(19) United States
(12) Patent Application Publication
(10) Pub. No.: US 2025/0072579 A1
(43) Pub. Date: Mar. 6, 2025

(54) MANICURE CURING DEVICE CAPABLE OF PREVENTING EXCESSIVE UNTRAVIOLET IRRADIATION

(71) Applicant: SHENZHEN WEILAI NAIL ART CO., LTD, SHENZHEN CITY, GUANGDONG PROVINCE (CN)

(72) Inventor: PINGPING XIONG, SHENZHEN CITY, GUANGDONG PROVINCE (CN)

(21) Appl. No.: 18/523,899

(22) Filed: Nov. 30, 2023

(30) Foreign Application Priority Data
Sep. 4, 2023 (CN) 202322405779.2

(51) Int. Cl. A45D 29/00; B05D 3/06

(52) U.S. Cl. CPC A45D 29/00; B05D 3/061

(57) ABSTRACT

A manicure curing device capable of preventing excessive ultraviolet irradiation is provided, including a housing having an internal cavity, in which the internal cavity has an upper surface, a left surface, a right surface and a lateral opening for entry and exit of a target; a first light-emitting module disposed at a front end of the upper surface; a second light-emitting module disposed at a rear end of the upper surface; a first control part configured to control the first light-emitting module to emit light and the second light-emitting module not to emit light; and a second control part configured to control the second light-emitting module to emit light and the first light-emitting module not to emit light.

### FIELD OF THE DISCLOSURE

The present disclosure relates to the technical field of manicure curing devices, and more particularly to a manicure curing device capable of preventing excessive ultraviolet irradiation.

### BACKGROUND OF THE DISCLOSURE

Manicure curing device, also known as manicure lamp or manicure phototherapy lamp, is specially used for drying and curing nail polish glue and phototherapy glue in the manicure process. When customers go to a nail salon to get a manicure and dry curing nail polish or nail phototherapy glue, they will obviously feel the discomfort of ultraviolet rays irradiating the back of their hands. Customers are worried that excessive exposure to ultraviolet rays will cause skin damage and increase the risk of skin cancer.

Based on this, it is necessary to improve the manicure curing device.

### SUMMARY OF THE DISCLOSURE

The purpose of the present disclosure is to provide a manicure curing device capable of preventing excessive ultraviolet irradiation that at least reduce illumination on the back of the hand in certain circumstances.

In order to achieve the above-mentioned purpose, the present disclosure provides a manicure curing device capable of preventing excessive ultraviolet irradiation, including: a housing having an internal cavity, in which the internal cavity has an upper surface, a left surface, a right surface and a lateral opening for entry and exit of a target; a first light-emitting module disposed at a front end of the upper surface; a second light-emitting module disposed at a rear end of the upper surface; a first control part configured to control the first light-emitting module to emit light and the second light-emitting module not to emit light; and a second control part configured to control the second light-emitting module to emit light and the first light-emitting module not to emit light.

In preferred embodiments, the first control part includes a first target detector disposed adjacent to the opening, and the second control part includes a second target detector spaced apart from the first target detector in a direction in which the target enters and exits the internal cavity.

In preferred embodiments, a distance between the second target detector and the first target detector is arranged such that when a thumb is configured not to enter the internal cavity, the target is not detected by the second target detector, and when the thumb is configured to enter the internal cavity, the target is detected by the second target detector.

In preferred embodiments, the first target detector and the second target detector are infrared sensors, and each of the first target detector and the second target detector is disposed on at least one of the left surface, the right surface and the upper surface of the internal cavity.

In preferred embodiments, the first target detector and the second target detector are touch sensors or pressure sensors, and each of the first target detector and the second target detector is disposed on a lower surface of the internal cavity.

In preferred embodiments, each of the first control part and the second control part is a control key disposed on an outer surface of the housing.

In preferred embodiments, each of the first control part and the second control part includes an image collector and an image processor, the image collector is configured to capture an image of the internal cavity, and the image processor is configured to identify a target from the image, and identify a location of the target or a number of fingers.

In preferred embodiments, the first light-emitting module is disposed in a front center area of the upper surface, a third light-emitting module is further disposed in a front left area and/or a front right area of the upper surface, and the third light-emitting module is configured to emit light together with the first light-emitting module in response to a signal from the first control part, and emit light together with the second light-emitting module in respond to a signal from the second control part.

In preferred embodiments, a fourth light-emitting module is correspondingly disposed at a front end of the left surface and a front end of the right surface, and the fourth light-emitting module is configured to emit light together with the first light-emitting module and the third light-emitting module.

In preferred embodiments, an inclined plane facing a center of the internal cavity is disposed between a rear surface and the left surface, and between the rear surface and the right surface. A fifth light-emitting module is disposed on the rear surface, a sixth light-emitting module is disposed on the inclined surface, and the fifth light-emitting module and the sixth light-emitting module are configured to emit light together with the second light-emitting module and the third light-emitting module.

In preferred embodiments, the housing includes a control key configured to set a lighting duration of each of the light-emitting modules.

In preferred embodiments, the manicure curing device capable of preventing excessive ultraviolet irradiation further includes an external keyboard. The external keyboard is wired or wirelessly connected to the manicure curing device, the external keyboard includes the first control part and the second control part, the first control part and the second control part are control keys, and the external keyboard further includes a control key configured to set a lighting duration of each of the light-emitting modules.

Compared with the existing technology, the present disclosure has at least the following beneficial effects.

As described above, by means of arranging the first light-emitting module at the front end of the upper surface of the internal cavity, arranging the second light-emitting module at the rear end of the upper surface, arranging the first control part to control the first light-emitting module to emit light and the second light-emitting module not to emit light, and arranging the second control part to control the second light-emitting module to emit light and the first light-emitting module not to emit light, the manicure curing device can work in a first state in which the light-emitting module at the front end of the upper surface emits light and the light-emitting module at the rear end of the upper surface does not emit light, and a second state in which the light-emitting module at the rear end of the upper surface emits light and the light-emitting module at the front end of the upper surface does not emit light. Therefore, compared with the existing manicure curing device in which all the light-emitting modules in the internal cavity emit light during operation, the manicure curing device of the present disclosure can at least reduce the illumination on the back of the hand in certain circumstances.

### BRIEF DESCRIPTION OF THE DRAWINGS

FIG. 1 is a perspective diagram of a manicure curing device according to an embodiment;

FIG. 2 is a schematic distribution diagram of a human body sensor according to an embodiment;

FIG. 3 is a schematic distribution diagram of a human body sensor according to another embodiment; and

FIG. 4 is a schematic distribution diagram of a light-emitting module according to an embodiment.

### DETAILED DESCRIPTION OF THE EXEMPLARY EMBODIMENTS

The present disclosure will be described in detail below in conjunction with drawings and examples.

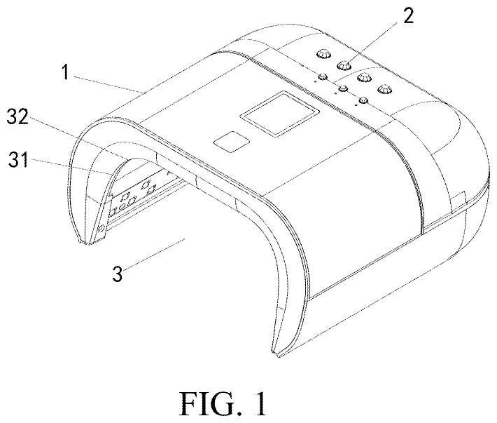

Reference is made to FIGS. 1-4. A manicure curing device of the present embodiment includes a housing 1, a first target detector 4, a second target detector 5, a first light-emitting module 14, a third light-emitting module 13, and a second light-emitting module 12.

The housing 1 has an internal cavity 3, and the internal cavity 3 has a lateral opening 31. The lateral opening 31 is configured to allow a target to enter and exit the internal cavity 3. The internal cavity 3 has a front surface 32, an upper surface 33, a left surface 34, a right surface 35 and rear surface 36. The lateral opening 31 is provided on the front surface 32 of the internal cavity 3.

In the following embodiments, a human hand will be taken as an example for explanation. It is understood that the same manicure curing device can process both hand nails and foot nails. In the present disclosure, the target may be a hand or a foot.

The first light-emitting module 14 is disposed in a front center area of the upper surface 33, the third light-emitting module 13 is disposed correspondingly in a front left area and a front right area of the upper surface 33, and the second light-emitting module 12 is disposed at a rear end of the upper surface 33. Specifically, the light-emitting module may be composed of a circuit substrate and at least one ultraviolet LED disposed on the circuit substrate.

The first target detector 4 serves as a first control part and is used to control the first light-emitting module 14 and the third light-emitting module 13 to emit light together, and the second light-emitting module 12 not to emit light. The second target detector 5 serves as a second control part and is used to control the third light-emitting module 13 and the second light-emitting module 12 to emit light together, and the first light-emitting module 14 not to emit light. Specifically, the first target detector 4 and the second target detector 5 can be electrically connected to an input end of a single-chip computer, and the first light-emitting module 14, the third light-emitting module 13 and the second light-emitting module 12 are correspondingly electrically connected to an output end of the single-chip computer. After the single-chip computer receives one signal from the first target detector 4, it controls the first light-emitting module 14 and the third light-emitting module 13 to emit light together, and the second light-emitting module 12 not to emit light. After the single-chip computer receives another signal from the second target detector 5, it controls the third light-emitting module 13 and the second light-emitting module 12 to emit light together, and the first light-emitting module 14 not to emit light. It is understood that the single-chip computer can also be replaced with an MCU or other microprocessors, or the corresponding human body sensor can also be directly connected to the power supply circuit of the corresponding light-emitting module to embody the above control of the light-emitting modules.

As described above, the first light-emitting module 14 is disposed in the front center area of the upper surface 33 of the internal cavity 3, the third light-emitting module 13 is disposed in the front left area and the front right area of the upper surface 33, and the second light-emitting module 12 is disposed at the rear end of the upper surface 33. The first control part is provided to control the first light-emitting module 14 and the third light-emitting module 13 to emit light together, and the second light-emitting module 12 not to emit light, and the second control part is provided to control the third light-emitting module 13 and the second light-emitting module 12 to emit light together, and the first light-emitting module 14 not emit light, so that the manicure curing device can work in a first state in which the light-emitting modules in the left, center, and right areas of the front end of the upper surface 33 all emit light and the light-emitting module at the rear end of the upper surface 33 does not emit light, and a second state in which the light-emitting modules in the left area, the right area and the rear end of the front end of the upper surface 33 all emit light and the light-emitting module in the front center area of the upper surface 33 does not emit light. Therefore, compared with the existing manicure curing device in which all the light-emitting modules in the internal cavity emit light during operation, the manicure curing device of the present embodiment can at least reduce illumination on the back of the hand in certain circumstances.

In the above embodiment, the first light-emitting module 14 is disposed in the front center area of the upper surface 33, the third light-emitting module 13 is disposed in the front left area and the front right area of the upper surface 33, and the second light-emitting module 12 is disposed at the rear end of the upper surface 33. In addition to reducing the illumination on the back of the hand in certain circumstance, it also enables that after responding to the information from the second control part, the light-emitting module in the center area of the front end of the upper surface 33 does not emit light, while the light-emitting modules in the left and right areas of the front end of the upper surface 33 emit light together with the light-emitting modules in the rear end of the upper surface 33. The light-emitting modules at the rear end can irradiate the nails of the three middle fingers of the human hand more effectively, while the light-emitting modules in the left and right areas of the front end can more effectively irradiate the nails of the fingers on both sides of the human hand, that is, the nails of the little finger and index finger are more effectively irradiated, so that the glue oil on the nails of all fingers can achieve a better curing effect. It can be understood that the present disclosure is not limited thereto, and the first light-emitting module may be provided only at the front end of the upper surface 33 and the second light-emitting module may be provided at the rear end of the upper surface 33 instead of the above-mentioned third light-emitting module. The first control part is used to control the first light-emitting module to emit light and the second light-emitting module not to emit light, and the second control part is used to control the second light-emitting module to emit light and the first light-emitting module not to emit light, so that it can also reduce exposure to the back of hands.

In addition, in the above embodiment, the first control part and the second control part adopt human body sensors, and the manicure curing device can automatically control the corresponding light-emitting module to emit light according to the position of the human hand extending into the internal cavity 3, without the need for manual control of the light-emitting module. Therefore, the manicure curing device of the present embodiment is also user-friendly.

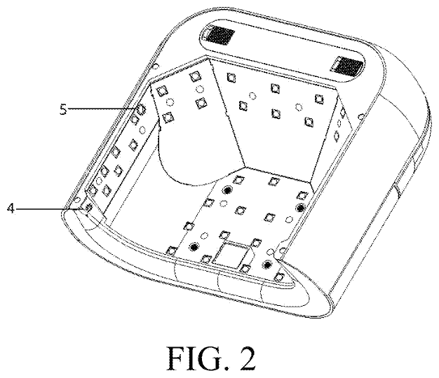

Reference is made to FIGS. 1 and 2. In one embodiment, the first target detector 4 is disposed adjacent to the opening 31, and the second target detector 5 is spaced apart from the first target detector 4 by a certain distance in a direction in which the human hand is configured to enter and exit the internal cavity 3.

In the present embodiment, when the human hand is configured to extend into the internal cavity 3, it can be recognized by the first target detector 4, and then the first light-emitting module 14 and the third light-emitting module 13 emit light together, and the second light-emitting module 12 does not emit light. Therefore, the present embodiment also has the characteristics of high control sensitivity.

In one embodiment, the distance between the second target detector 5 and the first target detector 4 is arranged such that when the thumb is configured not to enter the internal cavity 3, the human hand will not be detected by the second target detector 5, and when the thumb is configured to enter the internal cavity 3, the human hand will be detected by the second target detector 5.

In the present embodiment, when the other four fingers except the thumb all extend into the internal cavity 3, the nails of the four fingers correspond to the front center area, the front left area and the front right area of the upper surface 33. At the time, the human hand is detected by the first target detector 4 but cannot be detected by the second target detector 5. Therefore, the first light-emitting module 14 and the third light-emitting module 13 emit light together, and the second light-emitting module 12 does not emit light. Since the first light-emitting module 14 is located in the front center area of the upper surface 33 and the third light-emitting module 13 is located in the front left area and the front right area of the upper surface 33, the nails of the four fingers can be effectively irradiated at this time to achieve light curing. Since the second light-emitting module 12 is located at the rear end of the upper surface 33 and the fingers do not extend into the position, the second light-emitting module 12 does not emit light, which will not affect the curing effect and can prevent the second light-emitting module 12 from emitting light and slanting light to the back of the hand.

In the present embodiment, when all five fingers including the thumb extend into the internal cavity 3, the back of the hand corresponds to the front center area of the upper surface 33. At this time, the human hand is detected by the second target detector 5, therefore, the third light-emitting module 13 and the second light-emitting module 12 emit light together, and the first light-emitting module 14 does not emit light. The third light-emitting module 13 and the second light-emitting module 12 emit light together to effectively irradiate the nails of five fingers to achieve light curing. Since the back of the hand corresponds to the front center area of the upper surface 33, the first light-emitting module 12 disposed in the front center area does not emit light at this time, so the ultraviolet light irradiating the back of the hand can be reduced.

In one embodiment, the first target detector 4 and the second target detector 5 are infrared sensors, which are disposed on the left surface 34 of the internal cavity 3. Preferably, the positions in the height direction of the left surface 34 correspond to the entry and exit paths of human hands, which can improve sensing reliability. The infrared sensor can be of through-beam type or reflective type. It can be understood that when the first target detector 4 and the second target detector 5 are disposed on at least one of the left surface 34, the upper surface 33, and the right surface 35 of the internal cavity 3, the above effects can be obtained.

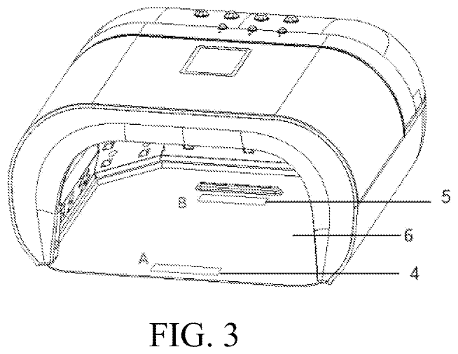

As shown in FIG. 3, in another embodiment, the first target detector 4 and the second target detector 5 are touch sensors, and each of the first target detector 4 and the second target detector 5 is disposed on the lower surface 6 of the internal cavity 3. When the human hand touches the corresponding touch sensor, it will be recognized by the touch sensor.

As yet another embodiment, the first target detector 4 and the second target detector 5 are pressure sensors, and the specific positions are shown in FIG. 3.

It can be understood that the purpose of arranging the first target detector and the second target detector in the present disclosure is to detect the position of the target entering the internal cavity of the manicure curing device through the combination of the first target detector and the second target detector, which is mainly achieved by the first target detector and the second target detector being separated by a certain distance in the direction of the human hand entering and exiting the internal cavity. Regarding the selection of the first target detector and the second target detector, it can be any existing target detection sensors, including but not limited to the above-mentioned infrared sensors, touch sensors, pressure sensors, photoelectric switches, etc.

In another embodiment, the first control part used to control the first light-emitting module 14 and the third light-emitting module 13 to emit light together and the second light-emitting module 12 not to emit light, and the second control part used to control the third light-emitting module 13 and the second light-emitting module 12 to emit light together and the first light-emitting module 14 not to emit light are each a control key. The control key is disposed on the outer surface of the housing 1. In the present embodiment, the control key can be used to control the manicure curing device to work in a corresponding light-emitting mode.

In another embodiment, an image collector is disposed on the upper surface of the internal cavity 3. The image collector is communicatively connected to the image processor. When working, the image collector collects an image of the internal cavity 3 and transmits the image to the image processor, and the image processor processes the image, and identifies whether the image contains human hands and identifies the number of fingers in the image. When the number of fingers is less than five, such as 1, 2, 3, 4, the first light-emitting module is controlled to emit light and the second light-emitting module is controlled not to emit light, or the first light-emitting module and the third light-emitting module are controlled to emit light together and the second light-emitting module is controlled not to emit light. When the number of fingers is five, the second light-emitting module is controlled to emit light and the first light-emitting module is controlled not to emit light, or the second light-emitting module and the third light-emitting module are controlled to emit light together, and the first light-emitting module is controlled not to emit light.

The image collector may also be configured to identify whether the human hand is included in the image, and identify the position of the human hand. Specifically, identifying the position of the human hand includes: identifying whether the human hand reaches the area corresponding to the first light-emitting module, and whether the human hand reaches the area corresponding to the second light-emitting module. When it is recognized that a human hand is included and the human hand reaches the area corresponding to the first light-emitting module, the first light-emitting module is controlled to emit light and the second light-emitting module is controlled not to emit light, or the first light-emitting module and the third light-emitting module are controlled to emit light together, and the second light-emitting module is controlled not to emit light. When it is recognized that a human hand is included and the human hand reaches the area corresponding to the second light-emitting module, the second light-emitting module is controlled to emit light and the first light-emitting module is controlled not to emit light, or the second light-emitting module and the third light-emitting module are controlled to emit light together and the first light-emitting module is controlled not to emit light.

Specifically, when it is recognized that the image contains human hands, the image can be compared with a pre-stored first image template. If a matching reaches a preset value, such as 90%, it is determined that the human hand has reached the area corresponding to the first light-emitting module; otherwise, it is determined that the human hand has not reached the area corresponding to the first light-emitting module. Similarly, the image can be compared with the pre-stored second image template. If the matching reaches a preset value, such as 90%, it is determined that the human hand has reached the area corresponding to the second light-emitting module; otherwise, it is determined that the human hand has not reached the area corresponding to the second light-emitting module.

In the above embodiment, the image collector and the image processor form the first control part and the second control part in the present disclosure.

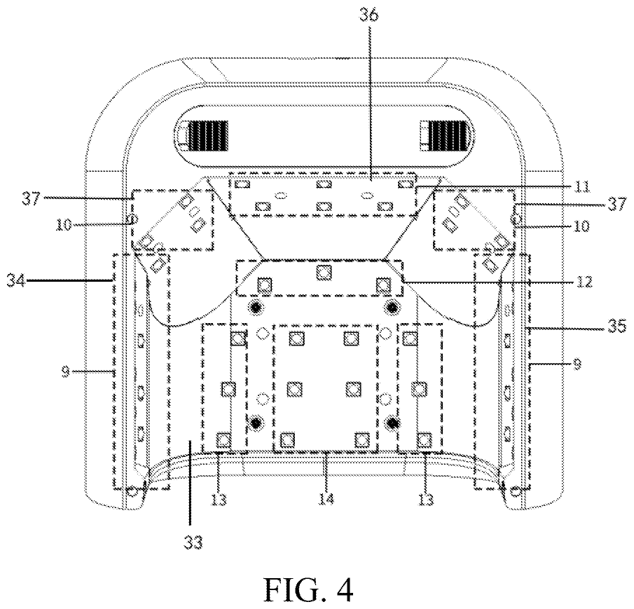

As shown in FIG. 4, in one particular embodiment, the fourth light-emitting module 9 is correspondingly disposed at the front end of the left surface 34 and the front end of the right surface 35 of the internal cavity 3, and the fourth light-emitting module 9 is configured to emit light together with the first light-emitting module 14 and the third light-emitting module 13, that is, they are triggered to emit light by the first control part. In the present embodiment, since the light-emitting modules are disposed at the front end of the upper surface 33, the front end of the left surface 34, and the front end of the right surface 35, in the working state with all four fingers except the thumb extending into the internal cavity 3, the nail can be irradiated from three directions: the upper side, the left side and the right side, so that a better curing effect is achieved.

As shown in FIG. 4, in one embodiment, an inclined surface 37 facing the center of the internal cavity 3 is disposed between the rear surface 36 and the left surface 34 of the internal cavity 3 and between the rear surface 36 and the right surface 35 of the internal cavity 3. A fifth light-emitting module 11 is disposed on the rear surface 36, and a sixth light-emitting module 10 is disposed on the inclined surface 37. The fifth light-emitting module 11 and the sixth light-emitting module 10 are provided to emit light together with the third light-emitting module 13 and the second light-emitting module 12. In the present embodiment, since the light-emitting modules are provided on the rear surface 36 and the inclined surface 37, when all five fingers, including the thumb, extend into the internal cavity 3, the nails can be irradiated from four directions, i.e., the upper side, the left side, the right side and the back side, so that a better curing effect is achieved.

As shown in FIG. 1, in one embodiment, a control key 2 is disposed on the upper surface of the housing 1. The control key includes a control key configured to set a lighting duration of the light-emitting module. In the present embodiment, the lighting duration of the light-emitting module can be selected through the control key. Therefore, the manicure curing device of the present embodiment can adapt to nail polish glue and phototherapy glue with different curing durations.

In one embodiment, an external keyboard is further provided. The external keyboard is wired or wirelessly connected to the manicure curing device. The external keyboard includes the first control part and the second control part. The first control part and the second control part are control keys, and the external keyboard further includes a control key configured to set a lighting duration of each of the light-emitting modules. The wired connection can be, for example, provided with a USB or other interface in the manicure curing device, and the electrical connection between an external keyboard and the manicure curing device is embodied through the interface. For wireless connection, for example, known wireless communication technologies such as Bluetooth® and WIFI can be used to embody the electrical connection between the external keyboard and the manicure curing device. In the present embodiment, the manicure curing device can be placed in the drawer of the manicure table for use, and the keyboard can be placed on the desktop of the manicure table or other places that are easy to operate. Therefore, the manicure curing device is suitable for use scenarios where it is placed in a place that is difficult to operate.

The present disclosure has been described in detail through specific embodiments. These detailed descriptions are only intended to help those skilled in the art understand the content of the present disclosure and cannot be construed as limiting the scope of the present disclosure. Various modifications, equivalent transformations, etc. made to the above solutions by those skilled in the art under the concept of the present disclosure should be included in the protection scope of the present disclosure.

What is claimed is:

1. A manicure curing device capable of preventing excessive ultraviolet irradiation, including:
a housing having an internal cavity, wherein the internal cavity has an upper surface, a left surface, a right surface and a lateral opening for entry and exit of a target;
a first light-emitting module disposed at a front end of the upper surface;
a second light-emitting module disposed at a rear end of the upper surface;
a first control part configured to control the first light-emitting module to emit light and the second light-emitting module not to emit light; and
a second control part configured to control the second light-emitting module to emit light and the first light-emitting module not to emit light.

2. The manicure curing device capable of preventing excessive ultraviolet irradiation according to claim 1, wherein
the first control part includes a first target detector disposed adjacent to the opening; and
the second control part includes a second target detector spaced apart from the first target detector in a direction in which the target enters and exits the internal cavity.

3. The manicure curing device capable of preventing excessive ultraviolet irradiation according to claim 2, wherein a distance between the second target detector and the first target detector is arranged such that when a thumb is configured not to enter the internal cavity, the target is not detected by the second target detector, and when the thumb is configured to enter the internal cavity, the target is detected by the second target detector.

4. The manicure curing device capable of preventing excessive ultraviolet irradiation according to claim 2, wherein the first target detector and the second target detector are infrared sensors, and each of the first target detector and the second target detector is disposed on at least one of the left surface, the right surface and the upper surface of the internal cavity.

5. The manicure curing device capable of preventing excessive ultraviolet irradiation according to claim 2, wherein the first target detector and the second target detector are touch sensors or pressure sensors, and each of the first target detector and the second target detector is disposed on a lower surface of the internal cavity.

6. The manicure curing device capable of preventing excessive ultraviolet irradiation according to claim 1, wherein each of the first control part and the second control part is a control key disposed on an outer surface of the housing.

7. The manicure curing device capable of preventing excessive ultraviolet irradiation according to claim 1, wherein each of the first control part and the second control part includes an image collector and an image processor, the image collector is configured to capture an image of the internal cavity, and the image processor is configured to identify a target from the image, and identify a location of the target or a number of fingers.

8. The manicure curing device capable of preventing excessive ultraviolet irradiation according to claim 1, wherein the first light-emitting module is disposed in a front center area of the upper surface, a third light-emitting module is further disposed in a front left area and/or a front right area of the upper surface, and the third light-emitting module is configured to emit light together with the first light-emitting module in respond to a signal from the first control part, and emit light together with the second light-emitting module in respond to a signal from the second control part; and/or
a fourth light-emitting module is correspondingly disposed at a front end of the left surface and a front end of the right surface, and the fourth light-emitting module is configured to emit light together with the first light-emitting module and the third light-emitting module.

9. The manicure curing device capable of preventing excessive ultraviolet irradiation according to claim 8, wherein an inclined plane facing a center of the internal cavity is disposed between a rear surface and the left surface, and between the rear surface and the right surface; a fifth light-emitting module is disposed on the rear surface, a sixth light-emitting module is disposed on the inclined plane, and the fifth light-emitting module and the sixth light-emitting module are configured to emit light together with the second light-emitting module and the third light-emitting module.

10. The manicure curing device capable of preventing excessive ultraviolet irradiation according to claim 1, wherein the housing includes a control key configured to set a lighting duration of each of the first light-emitting module and the second light-emitting module.

11. The manicure curing device capable of preventing excessive ultraviolet irradiation according to claim 1, further including an external keyboard, wherein the external keyboard is wired or wirelessly connected to the manicure curing device, the external keyboard includes the first control part and the second control part, the first control part and the second control part are control keys, and the external keyboard further includes a control key configured to set a lighting duration of each of the first light-emitting module and the second light-emitting module.
